(19) United States
(12) Patent Application Publication
(10) Pub. No.: US 2016/0133140 A1
(43) Pub. Date: May 12, 2016

(54) USING GROCERY STORE POINT-OF-SALE DATA TO CORRELATE CONSUMER PURCHASE HABITS TO NUTRITION TARGETS

(71) Applicant: Oracle International Corporation, Redwood Shores, CA (US)

(72) Inventors: Nigel KING, San Mateo, CA (US); Thijs Jonathan BAX, Ashford, Kent (GB)

(73) Assignee: Oracle International Corporation, Redwood Shores, CA (US)

(21) Appl. No.: 14/539,858

(22) Filed: Nov. 12, 2014

(51) Int. Cl. G09B 5/00; G06F 17/30; G06Q 40/00

(52) U.S. Cl. CPC G09B 5/00; G06Q 40/12; G06F 17/30525

(57) ABSTRACT

A method, system, and computer program product for wellness program management. Embodiments commence upon identifying a person as a wellness program participant and associating the person with a repository of grocer POS data using a personal identifier that is used to access the grocer POS data that comprises at least some food items purchased in a particular shopping trip. A set of consumer purchase records are retrieved from the POS data, then at least one aspect of a wellness profile pertaining to the wellness program participant is retrieved from wellness program data. The consumer purchase records can be analyzed to determine a nutrition value that is associated with at least one aspect of the wellness program participant's wellness profile. An alert is sent to the wellness program participant when certain events occur or when wellness profile thresholds are met.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

This disclosure relates to the field of wellness program management and more particularly to techniques for use grocery store point-of-sale data to correlate consumer purchase habits to nutrition targets.

### BACKGROUND

Enterprises big and small have implemented variations of wellness programs for their wellness program participants. In some cases, such wellness programs track wellness program participant participation in their wellness program, and in some cases such wellness programs include personalized tracking of various facets of an individualized wellness program. For example, a wellness program “activity tracker” might allow a wellness program participant to capture his or her performance of various fitness activities (e.g., steps per day, hours of bicycling, etc.). Also, a wellness program “nutrition tracker” might allow a wellness program participant to capture his or her performance to various dietary goals (e.g., calories per day, cholesterol reduction, daily water consumption, etc.).

Unfortunately, the task of capturing contributions to a wellness program participant's diet (e.g., what food items were consumed daily, or what snack were consumed in lieu of or between meals) can become arduous. What is desired is a way for a wellness program participant to provide an inventory of foodstuff to be consumed (e.g., foodstuff purchased in a grocery shopping trip) and use the inventory of foodstuff to calculate the contribution or correlation of the groceries to the wellness program participant's nutrition goals. Techniques are needed address the burden of meal-by-meal capture of a consumer's dietary consumption.

None of the aforementioned legacy approaches achieve the capabilities of the herein-disclosed techniques for using grocery store point-of-sale data to correlate consumer purchase habits to nutrition targets. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for use grocery store point-of-sale data to correlate consumer purchase habits to nutrition targets. The claimed embodiments address the problem of the burden of meal-by-meal capture of a consumer's dietary consumption. More specifically, some claims are directed to approaches for modeling the consumer's dietary consumption based on grocery purchases, which claims advance the technical fields for addressing the burden of meal-by-meal capture of a consumer's dietary consumption, as well as advancing peripheral technical fields. Some claims improve the functioning of multiple systems within the disclosed environments.

A method, system, and computer program product for wellness program management. Embodiments commence upon identifying a person as a wellness program participant and associating the person with a repository of grocer POS data using a personal identifier that is used to access the grocer POS data that comprises at least some food items purchased in a particular shopping trip. A set of consumer purchase records are retrieved from the POS data, then at least one aspect of a wellness profile pertaining to the wellness program participant is retrieved from wellness program data. The consumer purchase records can be analyzed to determine a nutrition value that is associated with at least one aspect of the wellness program participant's wellness profile. An alert is sent to the wellness program participant when certain events occur or when wellness profile thresholds are met.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

The drawings described below are for illustration purposes only. The drawings are not intended to limit the scope of the present disclosure.

FIG. 1A and FIG. 1B depict an environment in which systems that use grocery store point-of-sale data to correlate consumer purchase habits to nutrition targets can operate.

FIG. 2A depicts a front side of a loyalty card as found in systems that use grocery store point-of-sale data to correlate consumer purchase habits to nutrition targets, according to some embodiments.

FIG. 2B depicts a back side of a loyalty card as found in systems that use grocery store point-of-sale data to correlate consumer purchase habits to nutrition targets, according to some embodiments.

FIG. 3A presents a user interface for tracking meal consumption on a day-by-day basis as found in systems that use grocery store point-of-sale data to correlate consumer purchase habits to nutrition targets, according to an embodiment.

FIG. 3B presents a user interface for tracking nutrition targets on a day-by-day basis as found in systems that use grocery store point-of-sale data to correlate consumer purchase habits to nutrition targets, according to an embodiment.

FIG. 4A is a block diagram of a data flow of subcomponents found in systems that use grocery store point-of-sale data to correlate consumer purchase habits to nutrition targets, according to some embodiments.

FIG. 4B is a ladder diagram of a protocol for communication between subcomponents found in systems that use grocery store point-of-sale data to correlate consumer purchase habits to nutrition targets, according to some embodiments.

FIG. 5 is a block diagram of a data flow for generating nutrition tracking graphs as found in systems that use grocery store point-of-sale data to correlate consumer purchase habits to nutrition targets, according to one embodiment.

FIG. 6 presents a user interface for displaying nutrition targets as found in systems that use grocery store point-of-sale data to correlate consumer purchase habits to nutrition targets, according to an embodiment.

FIG. 7 is a block diagram of a system for using grocery store point-of-sale data to correlate consumer purchase habits to nutrition targets, according to one embodiment.

FIG. 8 is a block diagram of a system for using grocery store point-of-sale data to correlate consumer purchase habits to nutrition targets, according to one embodiment.

FIG. 9 depicts a block diagram of an instance of a computer system suitable for implementing embodiments of the present disclosure.

### DETAILED DESCRIPTION

Some embodiments of the present disclosure address the problem of the burden of meal-by-meal capture of a consumer's dietary consumption and some embodiments are directed to approaches for modeling the consumer's dietary consumption based on grocery purchases. More particularly, disclosed herein and in the accompanying figures are exemplary environments, methods, and systems for using grocery store point-of-sale data to correlate consumer purchase habits to nutrition targets.

### Overview

When an organization sponsors a wellness program, only some members participate in diet and nutrition tracking, and even when a comfortable human interface is provided for a wellness program participant to self-capture diet and nutrition, only some wellness program participants are so disciplined so as to stay up to date with the capture of the occurrence and contents of daily meals. Wellness program participants often report that the ongoing tasks involved in continuously tracking the occurrence and contents of daily meals is just too laborious. Wellness program participants often just “skip” the task of capturing the occurrence and contents of daily meals, so any calculations of nutrition or other dietary measures become skewed (e.g., underreporting of calories, etc.). Wellness program participants (e.g., members of an organization, or workers in a company) are interested in the correlation of their dietary intake to wellness, and in some cases wellness program participants are interested in the “points” (e.g., weight-watching points) or other motivational metrics (e.g., worker recognition or compensation) that may be provided within the wellness program, yet the burden of continuously tracking the occurrence and contents of daily meals is just too high.

One observation about dietary consumption is that just one meal does not alone constitute a “diet”, and tracking to a day-by-day or meal-by-meal level of granularity often does not show trends that are any more indicative of a “good diet” as are trends based on weekly tracking Empirical evidence substantiates that tracking on a less granular basis (e.g., a daily average of calories based on a once-a-week dietary consumption capture) is as correlated to wellness as is the more burdensome day-by-day or meal-by-meal granularity of capture.

Some of the techniques described herein retrieve data that has been collected at the grocery store checkout counter or other point of sale (POS). Described herein are techniques to allow retrieving grocery purchases to the item-by-item level, and relating those purchases to a nutrition goal of a particular wellness program participant. For example, grocery purchases made using a discount card or loyalty card registered to a particular consumer can be retrieved and can be used to approximate food intake (and corresponding nutrition). If the grocery purchases made by a particular consumer includes 14 apples, two bunches of bananas and a carton of baby formula, it can be imputed that that consumer's household consumes about 14 apples and two bunches of bananas per week as well as one carton of baby formula per week. For a family of two working adults and a baby, it is reasonable to impute that each adult consumes one apple and one banana per day. The nutrition derived from one apple and one banana per day can be added to the wellness program participant's nutrition profile.

In some cases a wellness program participant might set a self-imposed nutrition or diet target (e.g., average of 2000 calories per day, including no more than 400 calories from fats). When an imputed nutritional measure (e.g., number of calories per day, quantity of fruit per day) varies from a corresponding nutrition or diet target, then the wellness program participant can be alerted. Additionally, if the grocery purchases made using a discount card or loyalty card are deemed to be unhealthy and/or chronic and/or outside of a limit (e.g., 12 cans of strawberry cake frosting per week), the wellness program participant can be alerted with suggestions to aid in developing healthful food buying habits. In many cases, an alert can be correlated to a particular wellness program participant's own wellness program targets, and the wellness program participant can be notified as to reasons why the wellness program participant may not be reaching their nutrition targets. In some cases alerts can trigger remediation. In some cases an alert is delivered to the program participant's phone or other device, and in some cases the alert is accompanied with an audible signal (e.g., a chime) or a haptic signal (e.g., vibrate) or other sensory stimulation (e.g., to facilitate aversion therapy).

Further details regarding a general approach forming alerts and/or remediation recommendations are described in commonly-owned U.S. application Ser. No. 14/293,954, filed Jun. 2, 2014, entitled “FORMING RECOMMENDATIONS USING CORRELATIONS BETWEEN WELLNESS AND PRODUCTIVITY”, (Attorney Docket No. ORA140676-US-NP) which is hereby incorporated by reference in its entirety.

Some of the disclosures herein integrate an enterprise-sponsored wellness program with a grocer's point-of-purchase system. In this case the wellness program participant is relieved of capturing the details of grocery store purchases, and the grocer can know that the wellness program participant is involved in a wellness program. The grocer can avail yet another way to build a loyalty with the consumer. In particular, the consumer is motivated to frequent only the grocer or grocers associated with the wellness program participant's wellness program rather than to make their grocery purchases at random locations. Some of the disclosures herein integrate an enterprise-sponsored wellness program with the enterprise's human resources data systems. In exemplary situations, achievement of a wellness measure based on verifiable actions (e.g., high-nutrition foodstuff purchases) that are taken by the work force as a whole can serve to reduce health insurance premiums for both employers and employees. In certain situations, unhealthful “hot spots” (e.g., statistically high consumption of cigarettes) within a workforce can be identified, and remedial action (e.g., development and rollout of educational programs) can be taken by the enterprise and/or their healthcare payers or providers.

As described in the following figures, wellness program participants can avail themselves of various forms of automated correlation of grocery purchases to nutritional targets, and wellness program participant can more fully and more easily participate in employer incentive programs for fostering employee wellness.

### DEFINITIONS

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### Descriptions of Exemplary Embodiments

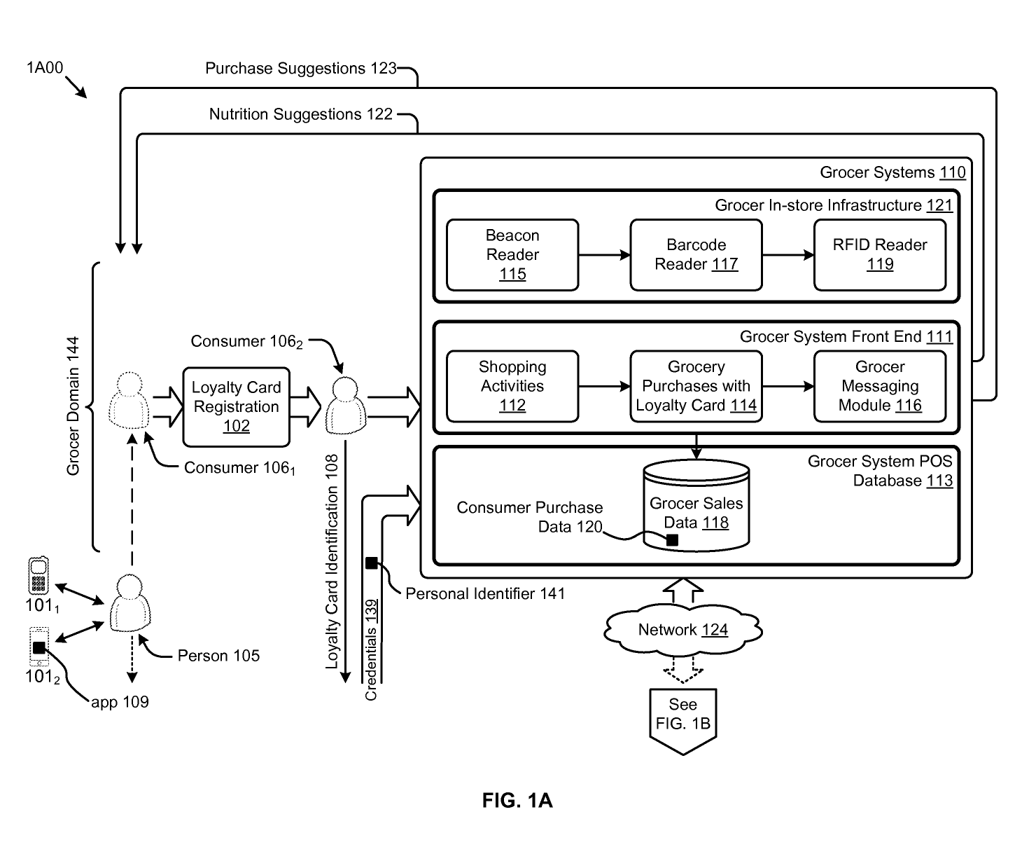

FIG. 1A and FIG. 1B depict an environment in which systems that use grocery store point-of-sale data to correlate consumer purchase habits to nutrition targets can operate. As shown in FIG. 1, the environment comprises a person 105, which person acts both as a consumer (e.g., consumer 1061, consumer 1062) as well as a wellness program participant (e.g., wellness program participant 1071, wellness program participant 1072). As a consumer, the person receives a grocer loyalty card and performs any of various forms of registration of the loyalty card with the grocer (e.g., see loyalty card registration module 102).

The person also acts as a wellness program participant, and enrolls or otherwise registers into a wellness program (e.g., a wellness program sponsored by the wellness program participant's company). The act or acts of registration into a wellness program (e.g., see wellness program registration module 104) may include establishing some initial biographical data (e.g., name, company ID, etc.), and may include one or more questionnaires pertaining to the wellness program participant's own stated wellness and/or wellness goals. Wellness goals may be related to any number of wellness factors, including without limitation aspects of daily activities, fitness activities, sleep patterns, diet, stress and other lifestyle factors.

Further details regarding a general approach to wellness goals are described in commonly-owned U.S. patent application Ser. No. 14/293,919, entitled “OPTIMIZING WELLNESS PROGRAM SPENDING” (Attorney Docket No. ORA140562-US-NP), filed Jun. 2, 2014, which is hereby incorporated by reference in its entirety.

Any of the foregoing factors can be managed individually and/or in combination with any wellness factors. In particular, a wellness program participant's diet can be managed as a wellness factor (e.g., by tracking meals eaten, snacks consumed, liquid consumed, coffee consumed, etc.). As heretofore mentioned, the burden of continuously tracking the occurrence and contents of daily meals can be reduced using the techniques described herein.

In particular, using the techniques described herein, foodstuff and other items purchased at a grocery store can be deemed to be consumed by the wellness program participant, and systems as described herein can relate consumer purchases and purchase habits to various wellness goals, including a nutrition goal.

As shown, the person, acting in the capacity as a consumer 1062 can associate himself with a grocer's personal identification for the consumer (e.g., using a loyalty card identification 108). Further, that same person acts as a wellness program participant 1072, and can register the grocer's personal identification for the consumer with a wellness program. In some environments, including the environment of FIG. 1A and FIG. 1B, a wellness program can be administrated using a computer-implemented program, such as in the form of wellness program application logic 126 (e.g., hosted on one or more application servers). The wellness program application logic can be partitioned to include user interface modules (e.g., user profile entry module 130, loyalty card entry module 128, a nutrition tracker entry module 132, etc.), and such interface modules can serve to interact with a person to capture their characteristics, wellness goals, and opt-in selections. Strictly as one example, a user profile entry module 130 can serve to capture any aspects of a wellness profile, which can be stored in an area accessible to a database engine (see FIG. 1B).

The consumer can perform various activities in the grocer domain 144 such as performance of shopping activities 112 and making grocery purchases with a loyalty card 114. In exemplary situations groceries purchased at a point-of-sale (POS) location are stored as grocer sales data 118, which can be stored within or accessible to one or more grocer systems 110. In some cases grocer systems are partitioned into a front end (e.g., grocer system front end 111) and a back end (e.g., grocer system POS database 113). A grocer system can comprise various in-store components (e.g., sensors deployed in various forms within grocer in-store infrastructure 121). The in-store infrastructure can be used in combination with other components in the grocer domain (e.g., the grocer system front end 111, grocer system POS database 113, etc.) to assist a consumer. For example, a grocer system may employ a beacon reader 115, a barcode reader 117 (e.g., an in-the-aisle barcode reader), and/or a radio frequency ID (RFID) reader (e.g., RFID reader 119), and such components may cooperate to provide information (e.g., nutrition suggestions 122, and/or purchase suggestions 123) to the consumer. In some situations, a grocer system front end includes a point-of-purchase terminal, and the consumer may receive coupons or other suggestions that are printed on a printer (not shown) after the purchases in the shopping trip have been totalized. Such coupons are provided after the consummation of the shopping trip, however in embodiments within environment 1A00, the grocer systems 110 provide suggestions (e.g., nutrition suggestions 122, purchase suggestions 123) to the consumer before the consummation of the shopping trip. The suggestions (e.g., nutrition suggestions 122, purchase suggestions 123) provided to the consumer before the consummation often comprises purchase assistance for consumers to aid in their wellness tracking. Strictly as one example, a beacon reader might detect that a consumer is standing stationary in front of a cake frosting display, and a nutrition suggestion such as “ . . . cake frosting is not on your selected diet plan” might be emitted. In another example a beacon reader might detect that a consumer is standing stationary in front of a the dairy case, and a nutrition suggestion such as “ . . . you might need milk” might be emitted, Such suggestions can be delivered to the consumer via any form of transducer (e.g., video display, speakers, etc.) and/or through use of the capabilities of a text phone 1011 or smart phone 1012. More particularly, the capabilities of a text phone 1011 or smart phone 1012 might include the capability of downloading and running a smart phone application (e.g., an app 109). The purchase suggestions serve to aid the consumer in achieving wellness goals, and such purchase suggestions are not intended merely to increase sales or maximize profitability of the shopping trip. In some situations, and as shown, the grocer system front end includes at least one instance of grocer messaging module 116, which can use any component of the in-store infrastructure and/or other components within the grocer domain to assist the consumer (e.g., by providing in-store navigation aids and/or wellness-related suggestions). In exemplary situations, the grocer messaging module 116 accesses wellness data (e.g., a wellness profile) over network 124, and uses the accessed data to generate wellness-related suggestions.

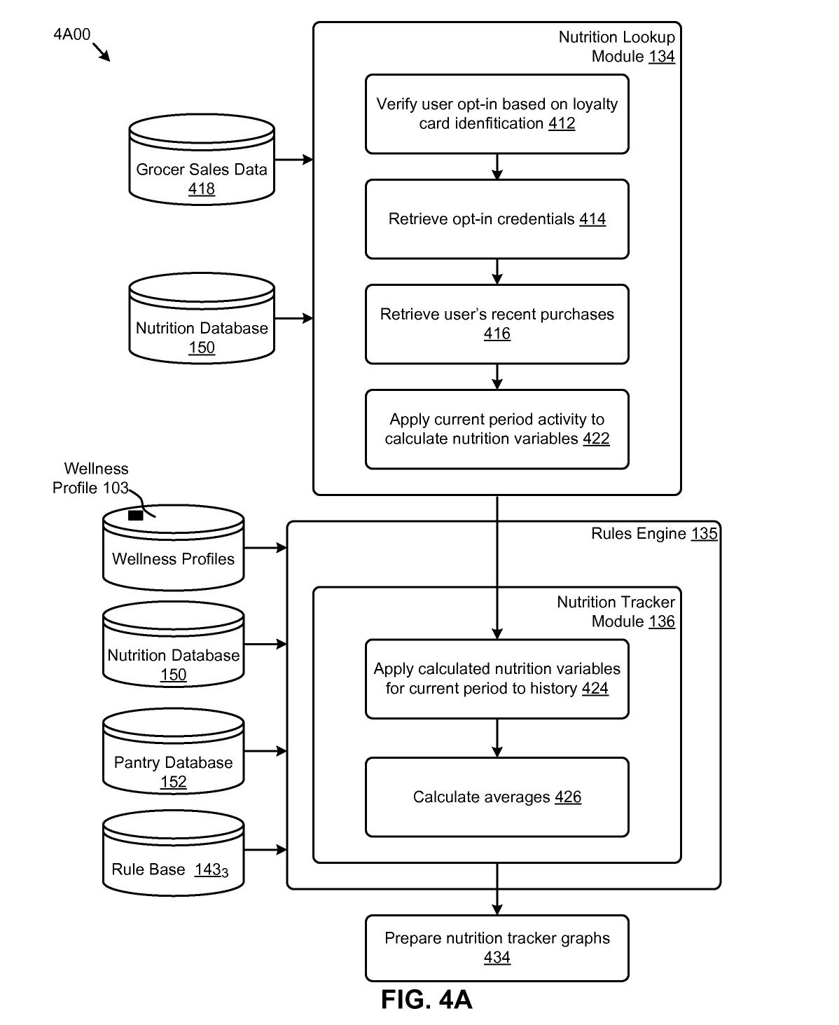

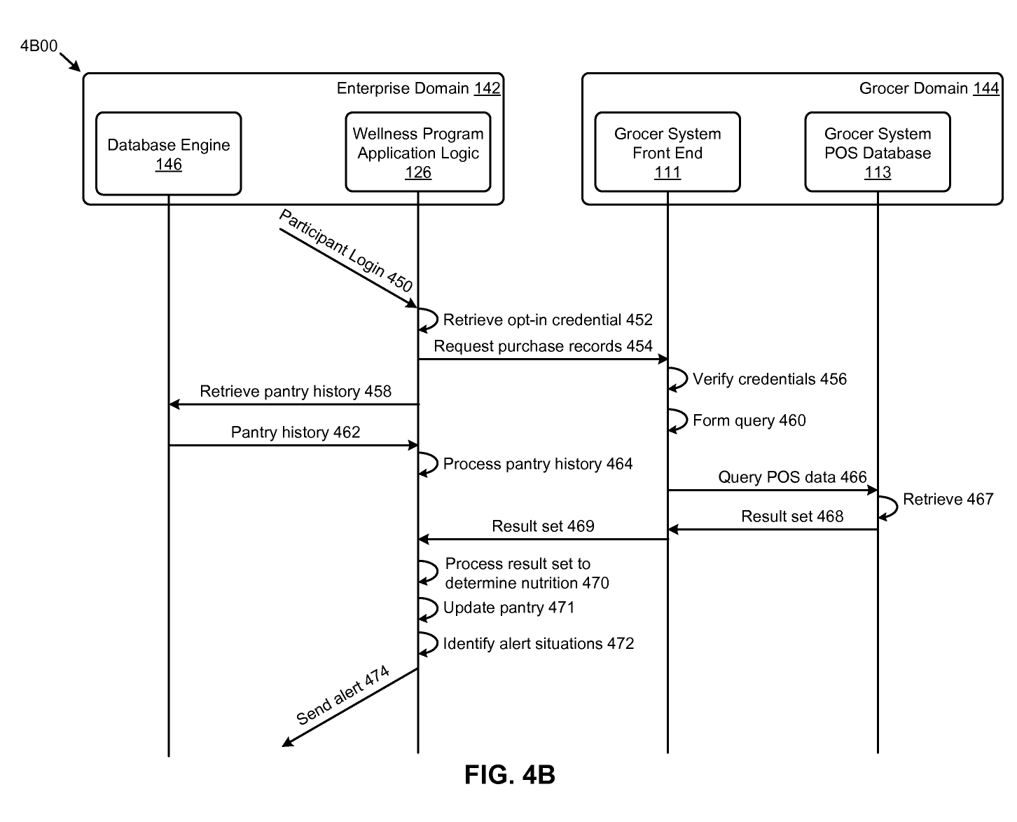

In many situations, confidentiality and privacy conventions may invoke the need for the grocer to share personally-identifiable information from the grocer domain 144 with modules within the enterprise domain 142 (or vice-versa). The need and limitations pertaining to sharing personally-identifiable information can be addressed by a protocol to share copies of credentials 139 (also see FIG. 4B).

In addition to exchanging credentials, the two parties (e.g., a grocery store and a corporate entity) can agree on privacy measures and/or features (e.g., sharing features, alert features, suggestion features, etc.) to offer to a person (e.g., a wellness program participant in the corporate entity, a consumer of groceries). Any feature can be subject to an acceptance (e.g., an opt-in) or a decline (e.g., an opt-out) by a person. The parties can exchange accept indications and/or decline indications and can observe such selections.

As shown in environment 1A00 and environment 1B00, once a linkage between the two parties has been established, and a person has accepted one or more sharing features, the wellness program application logic can poll the POS data of the grocer. For example, a module within the shown wellness program application logic 126 (e.g., a nutrition lookup module 134) can gain access to portions of the grocer systems (e.g., a grocer system POS database 113) and can retrieve records from consumer purchase data 120. In exemplary embodiments, an access protocol is observed by which the parties exchange, confirm and challenge credentials, which credentials serve to uniquely identify the person. In some cases, a loyalty card bearing the person's name and loyalty card identification serves to bind a personal identifier to a person. In other cases, a personal identifier can derive from an electronic serial number (ESN) of a mobile phone 101 (e.g., as read by a beacon reader 115). In the example of FIG. 1A, a specific instance of a personal identifier 141 is bound to a particular wellness program participant (e.g., an employee of the corporate entity who is also enrolled in the employer's wellness program). Also, the same value of the aforementioned specific instance of a personal identifier is bound to the consumer (a shopper who is registered into the grocer's loyalty program). As shown, consumer purchase data 120 can be retrieved by wellness program application logic 126 (e.g., using network 124).

Upon the grocer sharing POS data for a particular person, the nutrition lookup module 134 can use database engine 146 to access any instances of nutrition database 150. The shown nutrition database includes a mapping between a food item and its nutritional content. For example, a package of breakfast sausages with UPC “0123456789” can be mapped to a 200 gram package that contains approximately 200 grams of the food group “meat”. A single serving is 50 grams, and one serving corresponds to approximately 30% of a minimum required daily allowance (RDA) of protein and approximately 200 calories. A single shopping trip might include other food items, any of which can be mapped (e.g., using a UPC or other product identification) to nutritional content.

The contents of foodstuff from the shopping trip is added to a portion of stored data within the database engine (e.g., see pantry database 152). Future shopping trips can be added as well. Depletion of food items from the pantry database can modeled using perishability data 158 and/or consumption assumptions 156 (e.g., fresh fish will be deemed to have been 100% consumed within three days of the purchase). Additionally, depletion of food items from the pantry database can modeled using consumption assumptions 156 that relate to the household or living situation of the person. Strictly as one example, consumption of foodstuff within a household with two adults can be imputed to be apportions in approximate portions to each adult in the household. Other consumption assumptions are limitless, and often include, strictly as examples, a single adult in the household, a married couple in the household, a married couple with two children, a married couple with live-in parents, multi-family situations, etc. A wellness program participant can designate a household member to perform shopping activities on behalf of the wellness program participant.

Access to the grocer's POS system can be initiated at any point in time, for example using a polling technique such as when the wellness program participant logs into the nutrition tracker module 136 of the wellness program. The nutrition tracker module can poll and present up-to-date nutrition data to the wellness program participant, possibly including an alert 140. In some cases the up-to-date nutrition data is calculated based on goals define by the nutrition tracker entry module. For example, if the wellness program participant established (e.g., using the nutrition tracker entry module 132) a daily goal of 2000 calories per day, the nutrition tracker entry module might report a series of days (e.g., a week-long period) with an assessment of calories per day.

Just one meal or just one shopping trip does not alone constitute a “diet”. To reduce sampling errors introduced by temporally disparate or irregular patterns, a levelizer 138 is provided. Day-by-day or meal-by-meal consumption can be combined with levelized data from shopping trips, and averages (e.g., moving averages) can be calculated and presented to the wellness program participant vis-à-vis the wellness program participant's nutrition and/or other wellness goals. Over time, an average and/or moving average of commonly-consumed foodstuff can be presented to the employee.

In exemplary embodiments, occurrences (e.g., a shopping trip, purchase of a food item, purchase of a non-food item, etc.) can be captured in a learning model 145. A learning model can capture any sorts of events and/or aspects of an action, and/or a behavior, and/or a purchase pattern, etc. Further, such a learning model can be used as a predictor (e.g., if event A occurs, then what is probability that event B will occur) and such a learning model can be used in conjunction with a wellness program rule base (e.g., rule base 143₁, rule base 143₂, etc.). Strictly as one example, a wellness program rule base can comprise rules of the form: If <event> then <action taken to enter into learning model> and <action taken on behalf of a wellness program participant>. Following such an example rule format, if a wellness program participant purchases a can of strawberry cake frosting, then that occurrence and date and other POS data are entered into the learning model and the wellness program participant is alerted as to the impact that that purchase event has on the wellness program participant's goals. In some cases a rule need not include both <action taken to enter into learning model> and <action taken on behalf of a wellness program participant>. The occurrence of an event might be entered into the learning model without an alert, or the occurrence of an event might raise an alert without entering the event into the learning model.

A particular instance (e.g., rule base 143₁) of a wellness program rule base can comprise rules pertaining to generally held aspects of wellness and nutrition. A separate instance (e.g., rule base 143₂) might comprise rules that pertain to a particular wellness program participant. Strictly as one example, a rule base pertaining to a particular participant can comprise rules of the form: If <event> then <action taken to enter into learning model> and <action taken on behalf of a wellness program participant>. Following such an example rule, if a wellness program had raised an alert or suggestion to a participant purchases to “add green vegetables to your diet”, but the POS data of the current shopping trip does not include green vegetable purchases, then that occurrence and that determination is entered into the learning model and the wellness program participant is alerted as to the impact on his or her wellness program goals. An additional alert might be sent if the impact on his or her wellness program goals is above (or below) some threshold.

Some embodiments issue proactive alerts. For example, if during the course of assessing the impact of an event on a participant's wellness program goals the impact is deemed to be above (or below) some threshold, and/or if an event is deemed to form a trend, then a proactive remediation alert might be raised. For example, in addition to sending an alert that characterizes an event, or characterizes the impact on a participant's wellness program goals, one or more remediation alerts can be raised. If a participant's body weight goal is trending in the wrong direction, a remedial alert might be sent to the participant, “Spend a few more hours each week in the gym”. A trend reversal might be acknowledged by an inspirational message or reward of some form (e.g., coupon image or text message raised upon a beacon reading) when the participant is shopping at the participant's favorite grocer.

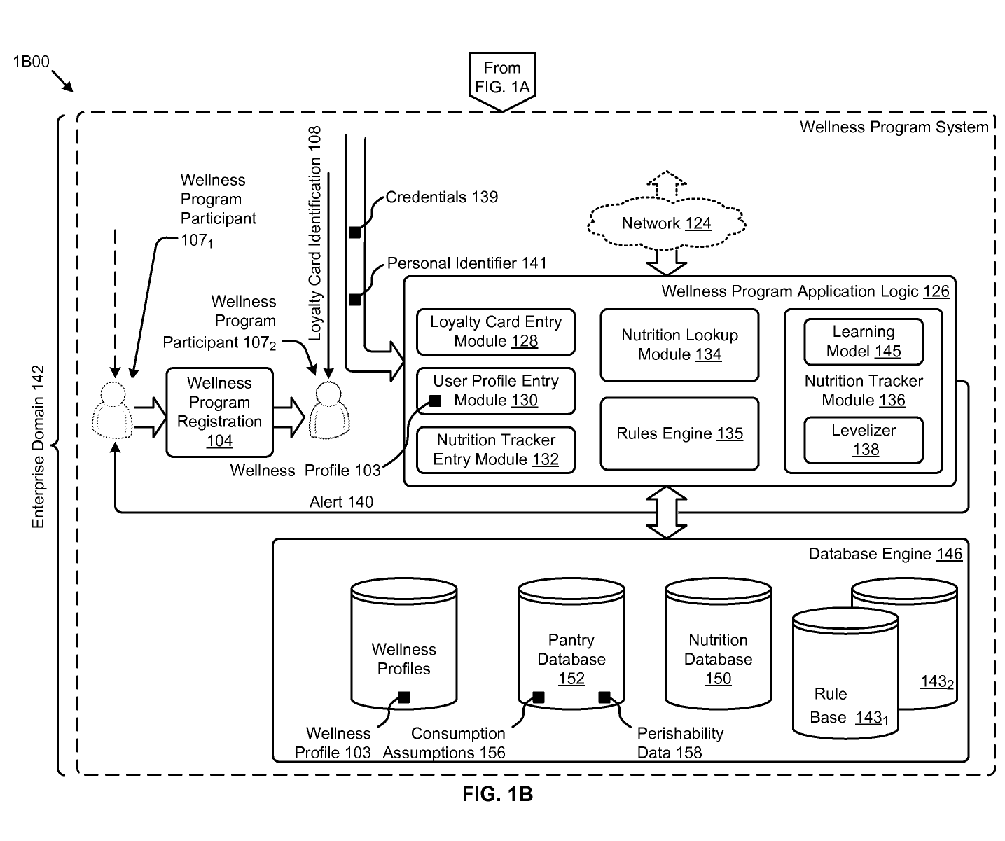

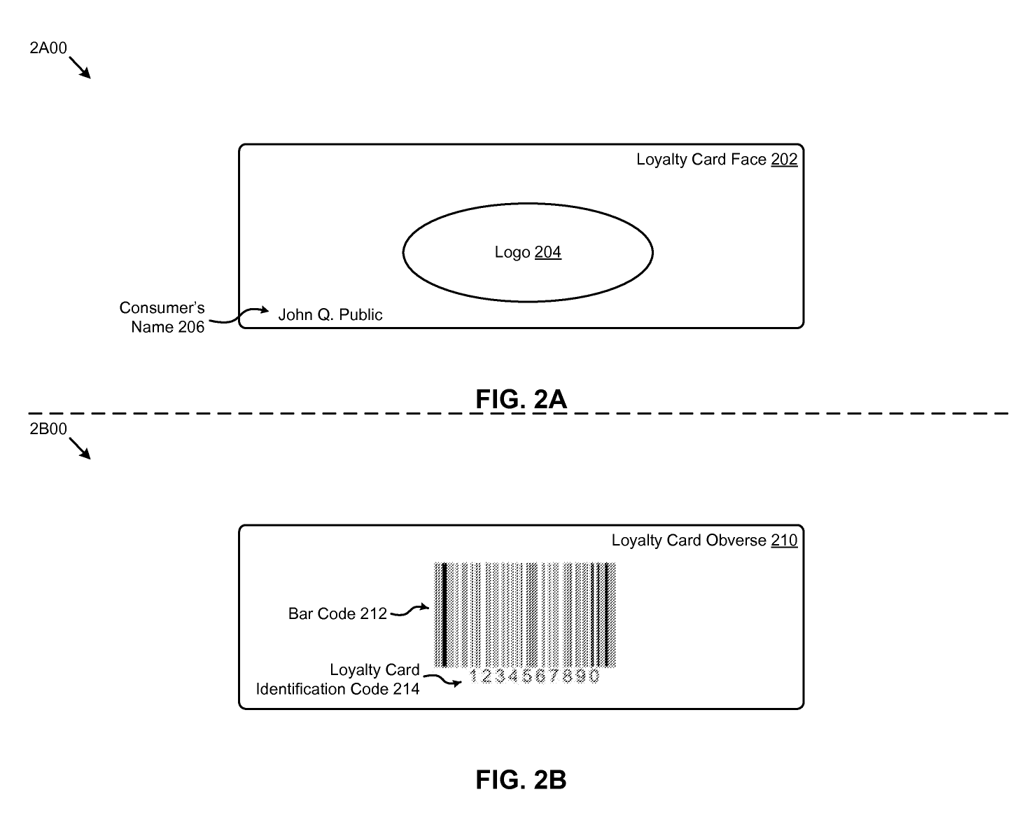

FIG. 2A depicts a front side of a loyalty card 2A00 as found in systems that use grocery store point-of-sale data to correlate consumer purchase habits to nutrition targets. As an option, one or more instances of loyalty card 2A00 or any aspect thereof may be implemented in the context of the architecture and functionality of the embodiments described herein. Also, the loyalty card 2A00 or any aspect thereof may be implemented in any desired environment.

As shown in FIG. 2A, the loyalty card face 202 comprises a grocer name, a logo 204 and a consumer's name 206. In most cases, the consumer's name need not be identical to the name of the wellness program participant. More specifically, the aforementioned registration processes, and the generation and exchange of credentials serves to associate a wellness program participant to a consumer.

A grocer may not issue a physical card such as loyalty card 2A00. In some cases, a grocer can identify a consumer on the basis of a downloaded smartphone app, or a POS scannable barcode displayed on a smartphone, or merely a telephone number.

FIG. 2B depicts a back side of a loyalty card 2B00 as can be used in systems that use grocery store point-of-sale data to correlate consumer purchase habits to nutrition targets. As an option, one or more instances of loyalty card 2B00 or any aspect thereof may be implemented in the context of the architecture and functionality of the embodiments described herein. Also, the loyalty card 2B00 or any aspect thereof may be implemented in any desired environment.

As shown in FIG. 2B, the loyalty card obverse 210 comprises a barcode 212 and a loyalty card identification code 214. The concept of loyalty in the term “loyalty card” need not imply any particular practice or extent of loyalty. In some cases a loyalty card is merely a discount card, and in some cases a loyalty card or its identification code is merely a means to uniquely identify a particular consumer. In still other cases, a grocer might use any means to uniquely identify a particular consumer so as to offer the particular consumer coupons or point summaries, or meal suggestions, or pairing suggestions, or nutrition suggestions, etc.

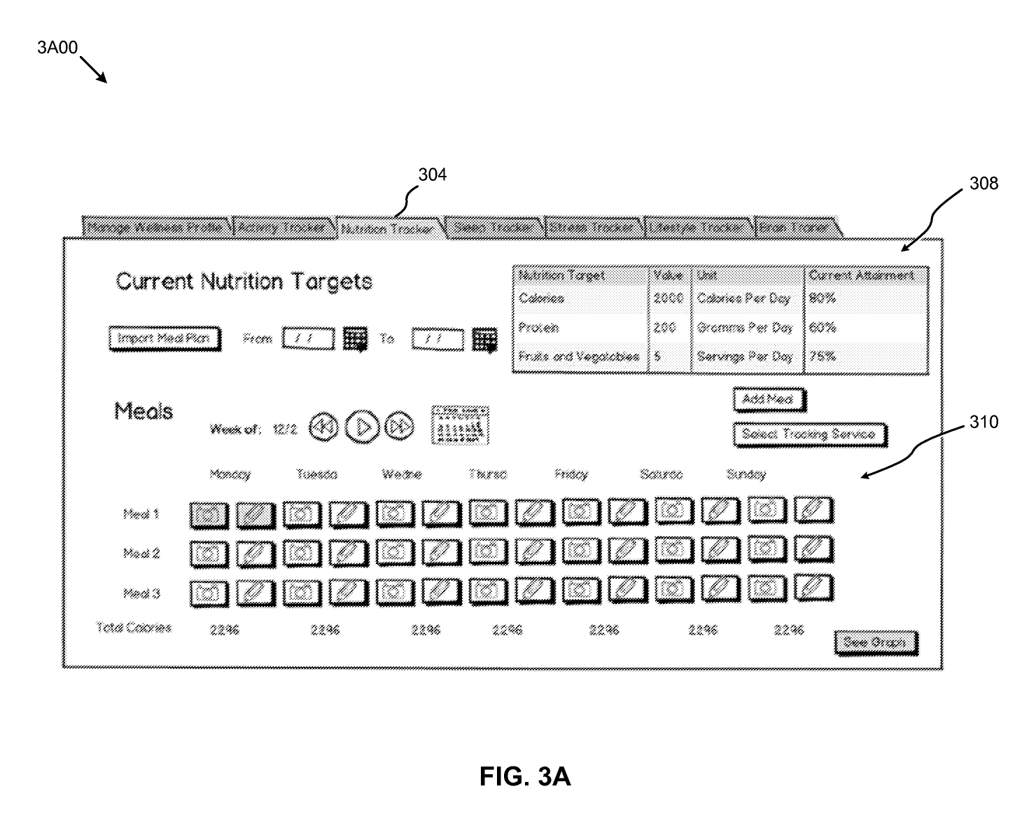

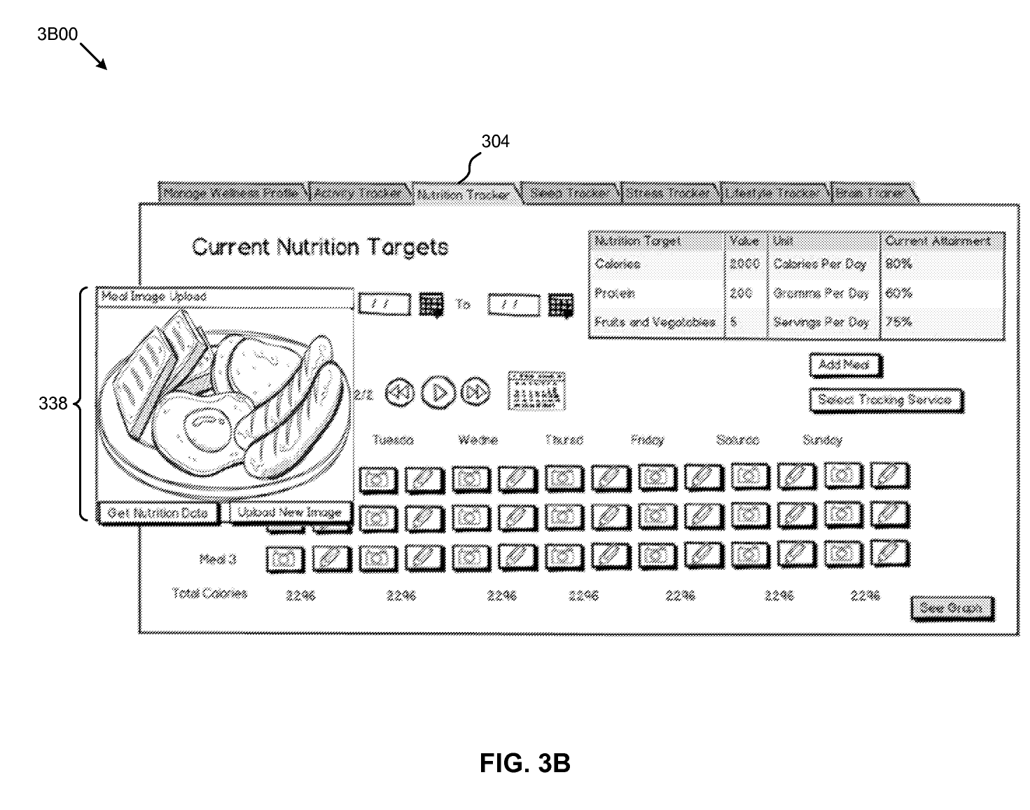

FIG. 3A presents a user interface 3A00 for tracking meal consumption on a day-by-day basis as found in systems that use grocery store point-of-sale data to correlate consumer purchase habits to nutrition targets. As an option, one or more instances of user interface 3A00 or any aspect thereof may be implemented in the context of the architecture and functionality of the embodiments described herein. Also, the user interface 3A00 or any aspect thereof may be implemented in any desired environment.

As shown in FIG. 3A, the user interface 3A00 includes a nutrition tracker tab 304, which in turn presents a depiction of a week-long series of meals presented in tracking array 310. In some embodiments a series of specific events (e.g., breakfast, lunch, dinner, or meal 1, meal 2, meal 3, etc.) can be presented in a tracking array 310. In some cases historical events (this morning's breakfast) or predicted events (tomorrow's dinner) are shown spanning a time period. The time period and characteristics of the events are configurable.

In exemplary cases, an event that falls in a shown time period can be clicked or touched, and various characteristics of that event can be shown graphically (e.g., as a photo, or as a dynamically-generated table). In the example discussed hereunder, Monday's breakfast included toast, sausage, eggs, and ham. In further embodiments, a meal plan can be adjusted to relate to schedules and/or characteristics of the user that impact food intake and/or goal-setting and/or tracking techniques. For example, a person who is working a night shift for a short period might tailor food intake to include a high-carbohydrate meal in the late afternoon or early evening (e.g., to emulate a normal diurnal cycle of high-carbohydrate breakfasts), and a high-protein meal around midnight (e.g., to emulate a normal diurnal cycle of high-protein dinners). In some embodiments, a background process can retrieve a wellness program participant's meal plan, and can serve to provide prompts to a wellness program participant. Such a prompt can be provided through any known means such as through a wellness program participant's choice of one or more communication channels (e.g., texting, short messaging SMS, email, social media postings, tweets, etc.), and in some cases, current attainment against any forms of nutrition targets 308 and/or instances of an alert 140 can be delivered to the wellness program participant.

Further, the burden of correlating any of the aforementioned schedules and/or characteristics of a wellness program participant to a nutrition plan can be facilitated by the presence of certain data items within a wellness application environment. For example, a wellness profile 103 can store work and vacation schedules, as well as any aspects of the wellness program participant as the wellness program participant may wish to use, in goal-setting and tracking. In some cases, successful tracking of progress to a goal can be demonstrated to an insurance carrier (e.g., by transmitting documentation pertaining to tracking of progress to a goal), and the insurance carrier might reduce a premium amount.

Further details regarding a general approach to wellness goals are described in commonly-owned U.S. patent application Ser. No. 14/293,890, entitled “USING CROWDSOURCING CONSENSUS TO DETERMINE NUTRITIONAL CONTENT OF FOODS DEPICTED IN AN IMAGE” (Attorney Docket No. ORA140467-US-NP), filed Jun. 2, 2014, which is hereby incorporated by reference in its entirety.

FIG. 3B presents a user interface 3B00 for tracking nutrition targets on a day-by-day basis as found in systems that use grocery store point-of-sale data to correlate consumer purchase habits to nutrition targets. As an option, one or more instances of user interface 3B00 or any aspect thereof may be implemented in the context of the architecture and functionality of the embodiments described herein. Also, the user interface 3B00 or any aspect thereof may be implemented in any desired environment.

As previously indicated, a series of specific events (e.g., breakfast, lunch, dinner, or meal 1, meal 2, meal 3, etc.) can be presented in a tracking array. An event that falls in a shown time period can be clicked or touched, and various characteristics of that event can be shown graphically. In the example of FIG. 3B, the user clicked on the event icon corresponding to Monday's breakfast, and food photo 338 is displayed. Metadata can be included as part of a food image. Such metadata can comprise a GPS coordinate (e.g., longitude and latitude) as may pertain to the location where the meal was consumed, or such metadata can comprise an establishment identification (e.g., as a text string or as an image), a wireless network name, and/or a timestamp. Such metadata can be used by a nutrition tracker module to identify patterns, and/or to impute consumption to a wellness program participant based on occurrence of specific events.

FIG. 4A is a block diagram of a data flow 4A00 between subcomponents found in systems that use grocery store point-of-sale data to correlate consumer purchase habits to nutrition targets. As an option, one or more instances of data flow 4A00 or any aspect thereof may be implemented in the context of the architecture and functionality of the embodiments described herein. Also, the data flow 4A00 or any aspect thereof may be implemented in any desired environment.

As shown in FIG. 4A, the data flow comprises a flow from a nutrition lookup module 134 to a rules engine 135 comprising a nutrition tracker module 136. The shown nutrition lookup module operates as follows: First, using the loyalty card identification, verify the user has accomplished an opt-in for specific access features (see operation 412). Second, in situations where the protocol between the grocer and the enterprise demand exchange of specific credentials corresponding to specific opt-in features, then retrieve the needed opt-in credentials (see operation 414). Third, retrieve the user's purchases (e.g., recent purchases 416) from the grocer's sales data 418. The grocer's sales data 418 may be retrieved over the network, or it make be a cached instance from an earlier access. Using the nutrition database 150, purchased foodstuff items are mapped to nutrition-related characteristics of the foodstuff, and nutrition variables are calculated to cover the current period (see operation 422).

Processing proceeds to the shown rules engine. The rules engine is configured to ingest a set of one or more rules (e.g., from rule base 143₃) and to process the rules over a set of data records. Such processing may invoking the shown nutrition tracker module 136. In this embodiment, the nutrition tracker module 136 operates as follows: First, a tracking history period is determined (e.g., a rolling 4 weeks) and nutrition variables determined for the current period are applied to the history (see operation 424). In this embodiment, moving averages are calculated (see operation 426) and processing proceeds to prepare nutrition tracker graphs (see operation 434).

Any or all of the steps or operations shown and discussed as pertains to this FIG. 4A can be accomplished in real-time, such as while the user is logged into a nutrition tracker tab 304. The following figure depicts one possible protocol between operational elements.

FIG. 4B is a ladder diagram of a protocol 4B00 for communication between subcomponents found in systems that use grocery store point-of-sale data to correlate consumer purchase habits to nutrition targets. The protocol 4B00 or any aspect thereof may be implemented in any desired environment. In some cases, the protocol is carried out using network 124, in other cases the protocol (or a portion therefrom) is carried out using communication channels other than network 124.

As shown in FIG. 4B, the protocol is carried our between an enterprise domain 142 and a grocer domain 144. The enterprise domain includes many operational components (see FIG. 1) of which the wellness program application logic 126 and database engine 146 serve to carry out enterprise domain portions of protocol 4B00. The grocer domain includes many operational components (see FIG. 1) of which the grocer system front end 111 and grocer system POS database 113 serve to carry out grocer domain portions of protocol 4B00.

The shown protocol commences upon a wellness program participant log-in event (see message 450), to which event the wellness program application logic retrieves credentials (see operation 452), including the wellness program participant's opt-in credentials (if any). The retrieved credentials are used to request that wellness program participant's POS purchase records (see message 454). The grocer system front end verifies the passed-in credentials (see message 456). Some portion of the contents of message 454 are used by the grocer system front end to form a query (see operation 460). The grocer system POS database processes the query (see message 466 and operation 467), so as to return a result set to the grocer system front end (see message 468), which in turn relays the result set to wellness program application logic (see message 469). The result set comprises a date and time, and a set of UPC codes corresponding to the items purchased by the wellness program participant/consumer in that shopping trip or checkout session. Operational components within the enterprise domain (e.g., a nutrition lookup module 134) serve to process the result set to determine the nutritional content of the items purchased (see operation 470). The wellness program participant's pantry is updated (see message 458, and message 462, and operation 464) and the wellness program participant's pantry is updated (see operation 471). Any aberrations discovered in the process of updating the pantry can raise an alert (see operation 472). In some cases additional processing is performed in response to the occurrence of the shopping trip(s) or check-out session(s). For example, the nutrition tracker module 136 might be invoked so as to levelize nutrition values and/or to calculate moving averages. If and when any aberrations are discovered, the wellness program application logic or its constituent components can raise an alert (see operation 472), possibly by sending the alert (see message 474) to the wellness program participant using any one or more of a wellness program participant's choices communication channels (e.g., texting, short messaging SMS, email, social media postings, tweets, etc.).

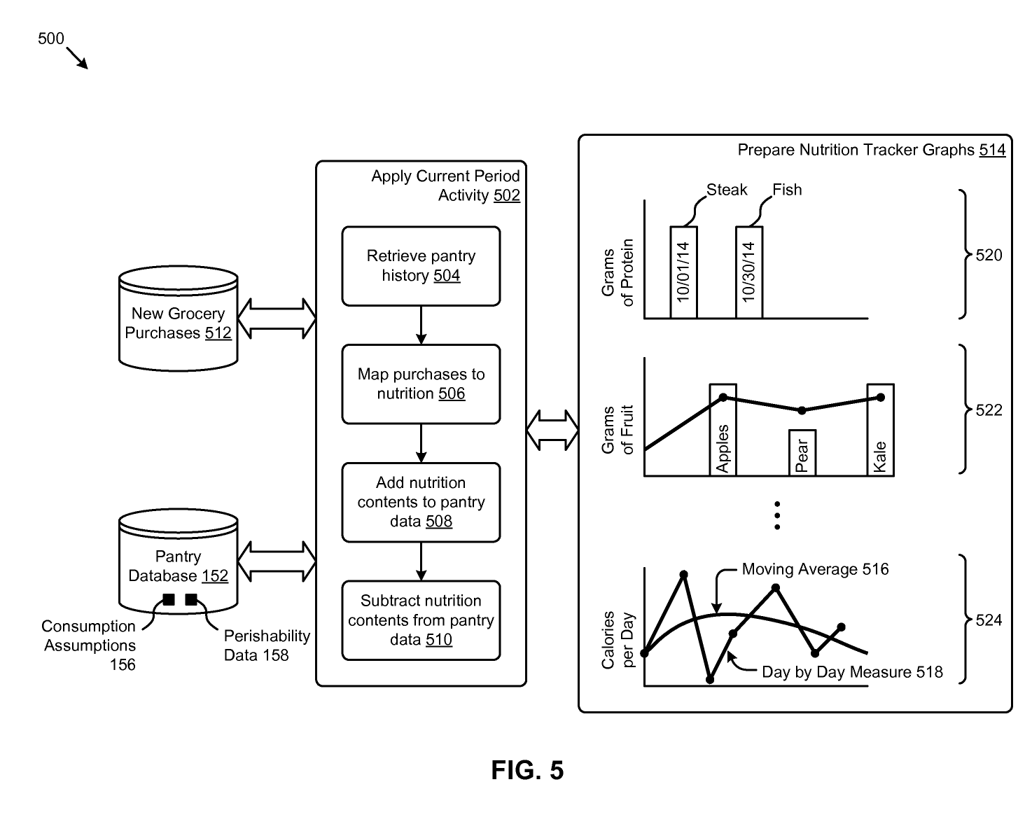

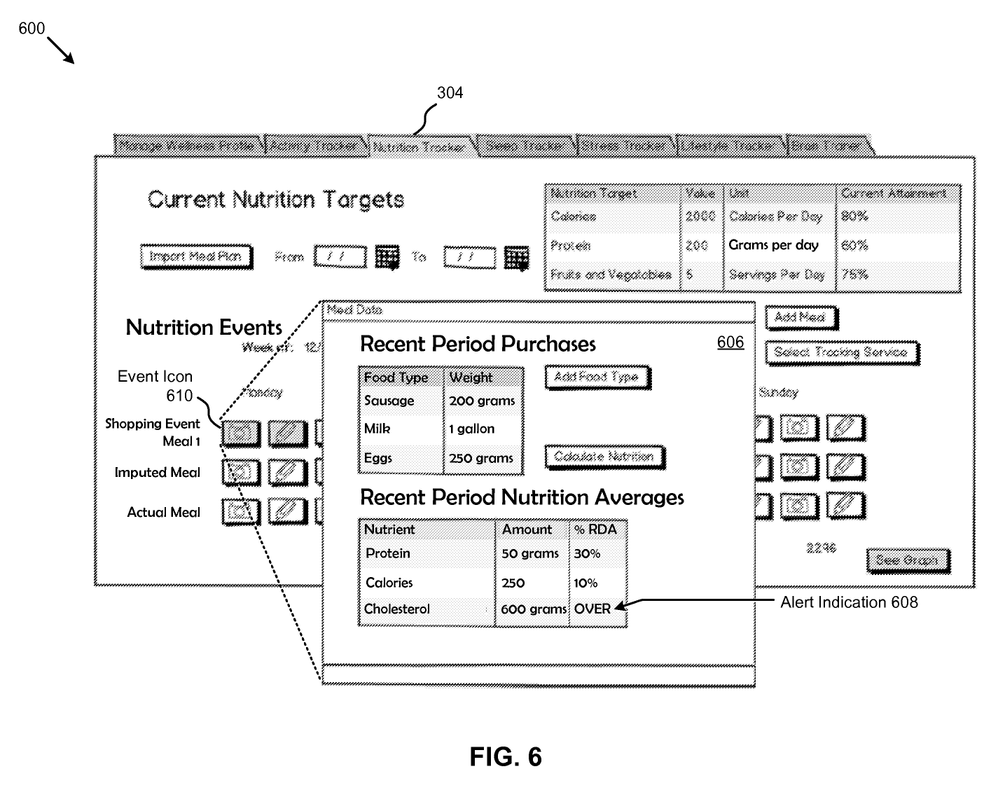

In addition to forming and sending alerts as heretofore discussed, processing of the shopping trip vis-à-vis the pantry, and/or processing the shopping trip vis-à-vis the wellness program participant's wellness targets and/or nutrition targets can result in updates to a wellness program participant's trends and/or graphs and/or other aspects of the wellness program participants user interfaces (as may be customized using the wellness program participant's wellness profile 103). Development and presentation of such trends and/or graphs are discussed in the following FIG. 5 and FIG. 6.

FIG. 5 is a block diagram of a data flow 500 for generating nutrition tracking graphs as found in systems that use grocery store point-of-sale data to correlate consumer purchase habits to nutrition targets. The data flow 500 or any aspect thereof may be implemented in any desired environment.

As shown in FIG. 5, the data flow comprises a flow to apply current period activity (see flow 502) and a flow to prepare nutrition tracker graphs (see flow 514). The flows can communicate directly (e.g., using messaging or data structure passing between the flows) and/or by techniques involving storage and retrieval of data using a database engine 146.

In applying current period activity, flow 502 retrieves pantry history (see step 504). Then, the current period activity (e.g., foodstuff purchases) is mapped to constituent nutrition (see step 506) and any nutritional content found in new grocery purchases 512 is added to the pantry data (see step 508). The timeframe of the current period and the timeframe of the retrieved pantry history is compared, and the nutritional contents of the pantry are adjusted to account for the passage of time (see step 510). For example the contents of the pantry can be adjusted by considering semantics of the perishability data 158 to remove items that are deemed to have been consumed and/or to remove expired perishables. Any forms of consumption assumptions 156 can be considered in adjusting the contents of the pantry.

Any of the foregoing adjustments and/or calculations of nutritional contents can be provided to the flow to prepare nutrition tracker graphs (see flow 514). Graphs are generated (e.g., for display in a user interface). Strictly as an example, a graph might present a time sequence of purchases of foodstuff as broken out into protein content. As shown, the graph 520 depicts grams of protein purchased over time, which graph includes a date indication (e.g., the date of the shopping trip). Some embodiments include identification of the particular food item that contributes the protein.

In another embodiment, example graph 522 depicts a time sequence of purchases of foodstuff as broken out into fruits and vegetables. Example graph 522 includes identification of the particular food items that are allocated to the fruits and vegetables food group or nutrition category.

In yet another example, a calories per day chart 524 depicts calories per day as a day-by-day measure 518 as well as a moving average 516. The day-by-day measure 518 as well as a moving average 516 can be calculated using a combination of meals as entered by the wellness program participant (e.g. see FIG. 3A and FIG. 3B), together with imputed meals as determined by the wellness program application logic (see FIG. 1).

The foregoing descriptions of nutrition graphs are merely examples. Other user interface presentations are possible, some of which are discussed as pertaining to FIG. 6.

FIG. 6 presents a user interface 600 for displaying nutrition targets as found in systems that use grocery store point-of-sale data to correlate consumer purchase habits to nutrition targets. As an option, one or more instances of user interface 600 or any aspect thereof may be implemented in the context of the architecture and functionality of the embodiments described herein. Also, the user interface 600 or any aspect thereof may be implemented in any desired environment.

As shown in FIG. 6, the user interface comprises a pop-up window 606 that appears in response to a click or touch on an event icon 610. The pop-up describes the event using the nutrition information as pertains to a shopping trip (as shown) or of an actual meal, or as pertains to a levelized assessment (e.g., an imputed meal) of nutrition based on calculations from consumer purchase data 120, in conjunction with the nutrition database 150 and the pantry database 152. In exemplary cases, the nutritional value of the meal is presented in several categories. For example, the nutritional value of the meal can include a breakdown into protein, calories, cholesterol, and can further provide an indication of minimum daily requirements and/or amounts in excess of daily norms. Tracking of actual intake as compared with a target can be shown in a chart (e.g., as presented in FIG. 5). In some cases, an alert indication 608 is presented when the recent period nutrition averages are over (or under) nutrition recommendations.

The foregoing user interface is merely one example to show nutrition targets (e.g., calories, protein consumed, fruits and vegetables consumed, etc.) in combination with statistically outstanding events such as a meal event that invoked an alert (e.g., meal data as shown in pop-up window 606).

### Additional Embodiments of the Disclosure

### Additional Practical Application Examples

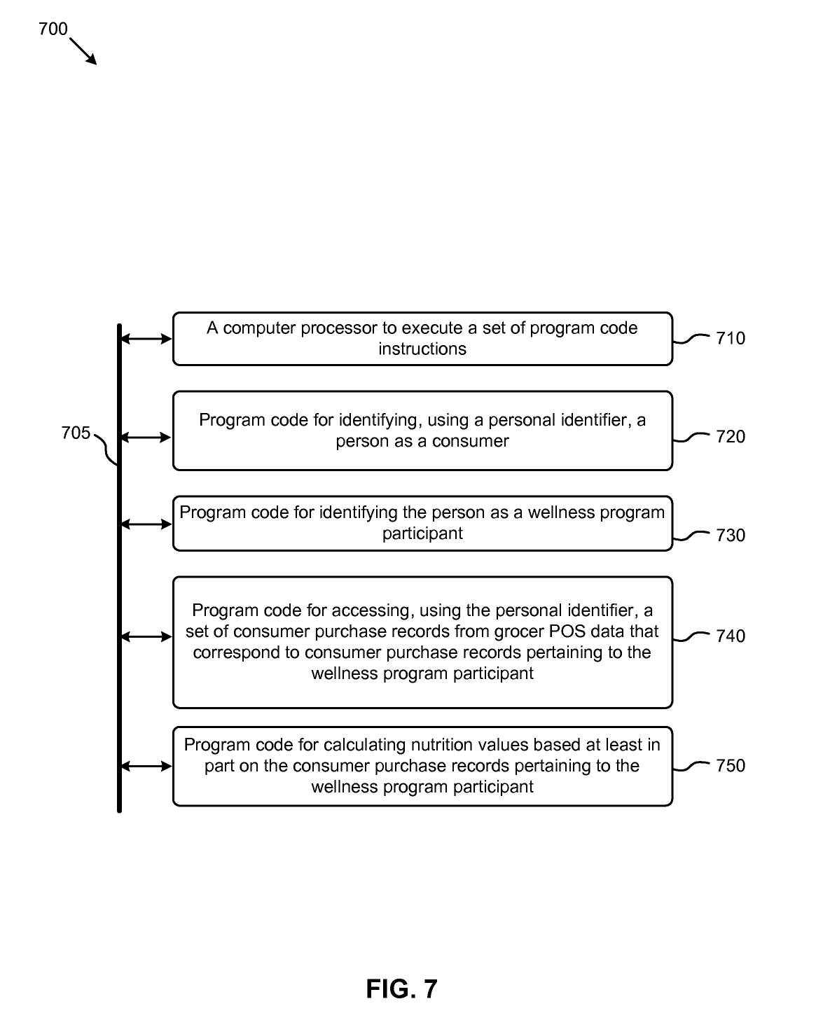

FIG. 7 is a block diagram of a system for use grocery store point-of-sale data to correlate consumer purchase habits to nutrition targets. FIG. 7 depicts a block diagram of a system to perform certain functions of a computer system. As an option, the present system 700 may be implemented in the context of the architecture and functionality of the embodiments described herein. Of course, however, the system 700 or any operation therein may be carried out in any desired environment. As shown, system 700 comprises at least one processor and at least one memory, the memory serving to store program instructions corresponding to the operations of the system. As shown, an operation can be implemented in whole or in part using program instructions accessible by a module. The modules are connected to a communication path 705, and any operation can communicate with other operations over communication path 705. The modules of the system can, individually or in combination, perform method operations within system 700. Any operations performed within system 700 may be performed in any order unless as may be specified in the claims. The embodiment of FIG. 7 implements a portion of a computer system, shown as system 700, comprising a computer processor to execute a set of program code instructions (see module 710) and modules for accessing memory to hold program code instructions to perform: identifying, using a personal identifier, a person as a consumer (see module 720); identifying the person as a wellness program participant (see module 730); accessing, using the personal identifier, a set of consumer purchase records from grocer POS data that correspond to consumer purchase records pertaining to the wellness program participant (see module 740); and calculating a nutrition value based at least in part on the consumer purchase records pertaining to the wellness program participant (see module 750).

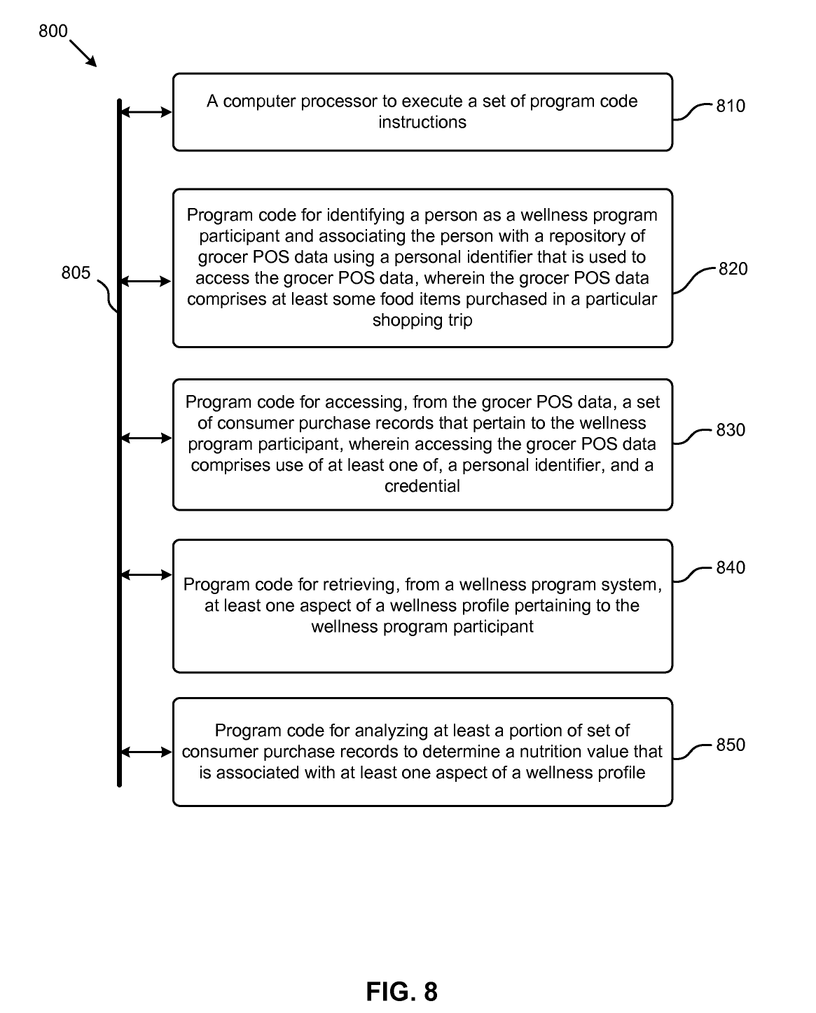

FIG. 8 is a block diagram of a system for using grocery store point-of-sale data to correlate consumer purchase habits to nutrition targets. As an option, the present system 800 may be implemented in the context of the architecture and functionality of the embodiments described herein. Of course, however, the system 800 or any operation therein may be carried out in any desired environment. As shown, system 800 comprises at least one processor and at least one memory, the memory serving to store program instructions corresponding to the operations of the system. As shown, an operation can be implemented in whole or in part using program instructions accessible by a module. The modules are connected to a communication path 805, and any operation can communicate with other operations over communication path 805. The modules of the system can, individually or in combination, perform method operations within system 800. Any operations performed within system 800 may be performed in any order unless as may be specified in the claims. The embodiment of FIG. 8 implements a portion of a computer system, shown as system 800, comprising a computer processor to execute a set of program code instructions (see module 810) and modules for accessing memory to hold program code instructions to perform: identifying a person as a wellness program participant and associating the person with a repository of grocer POS data using a personal identifier that is used to access the grocer POS data, wherein the grocer POS data comprises at least some food items purchased in a particular shopping trip (see module 820); accessing, from the grocer POS data, a set of consumer purchase records that pertain to the wellness program participant, wherein accessing the grocer POS data comprises use of at least one of, a personal identifier, and a credential (see module 830); retrieving, from a wellness program system, at least one aspect of a wellness profile pertaining to the wellness program participant (see module 840); and analyzing at least a portion of set of consumer purchase records to determine a nutrition value that is associated with at least one aspect of a wellness profile (see module 850).

Other implementations include an interconnection between modules and functions such as, for example, a database comprising a set of storage devices to hold a set of data records, wherein the data records comprise POS data having at least some items purchased relative to a personal identifier; a rules engine to ingest a set of one or more rules and to process the rules over the data records; a rule base comprising a set of one or more processing rules for analysis of the POS data; a database engine to access, from the POS data, a set of purchase records that pertain to the personal identifier, wherein accessing the POS data comprises use of at least one of, a personal identifier, and a credential; and an application server to execute the rules using the database engine to retrieve at least one aspect of a profile pertaining to personal identifier. Further modules can be configured to analyze at least a portion of the set of purchase records to determine a nutrition value.

### System Architecture Overview

### Additional System Architecture Examples

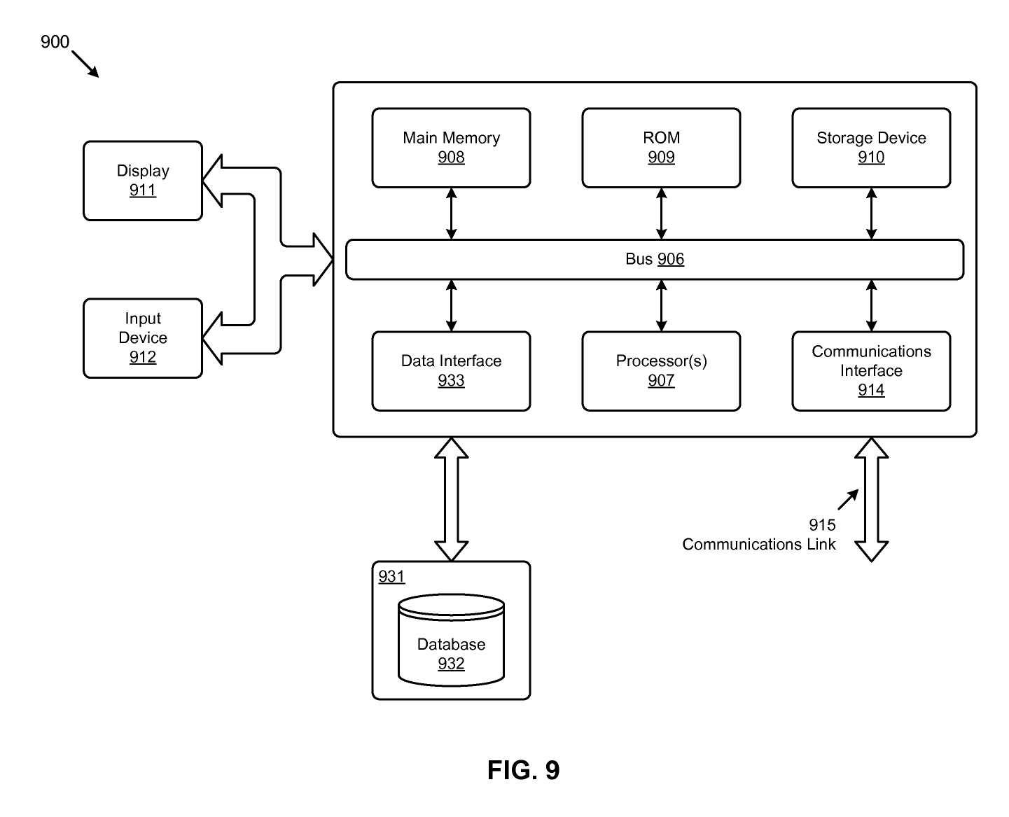

FIG. 9 depicts a block diagram of an instance of a computer system 900 suitable for implementing embodiments of the present disclosure. Computer system 900 includes a bus 906 or other communication mechanism for communicating information, which interconnects subsystems and devices such as a processor 907, a system memory (e.g., main memory 908, or an area of random access memory RAM), a static storage device (e.g., ROM 909), a storage device 910 (e.g., magnetic or optical), a data interface 933, a communication interface 914 (e.g., modem or Ethernet card), a display 911 (e.g., CRT or LCD), input devices 912 (e.g., keyboard, cursor control), and an external data repository 931.

According to one embodiment of the disclosure, computer system 900 performs specific operations by processor 907 executing one or more sequences of one or more instructions contained in system memory. Such instructions may be read into system memory from another computer readable/usable medium such as a static storage device or a disk drive. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 907 for execution. Such a medium may take many forms including, but not limited to, non-volatile media and volatile media. Non-volatile media includes, for example, optical or magnetic disks such as disk drives or tape drives. Volatile media includes dynamic memory such as a RAM memory.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 900. According to certain embodiments of the disclosure, two or more instances of computer system 900 coupled by a communications link 915 (e.g., LAN, PTSN, or wireless network) may perform the sequence of instructions required to practice the disclosure in coordination with one another.

Computer system 900 may transmit and receive messages, data, and instructions including programs (e.g., application code), through communications link 915 and communication interface 914. Received program code may be executed by processor 907 as it is received and/or stored in storage device 910 or any other non-volatile storage for later execution. Computer system 900 may communicate through a data interface 933 to a database 932 on an external data repository 931. Data items in database 932 can be accessed using a primary key (e.g., a relational database primary key). A module as used herein can be implemented using any mix of any portions of the system memory and any extent of hard-wired circuitry including hard-wired circuitry embodied as a processor 907. Some embodiments include one or more special-purpose hardware components (e.g., power control, logic, sensors, etc.).

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A system comprising:
a database comprising a set of storage devices to hold a set of data records, wherein the data records comprise POS data having at least some items purchased relative to a personal identifier;
a rules engine to ingest a set of one or more rules and to process the rules over the data records;
a rule base comprising a set of one or more processing rules for analysis of the POS data;
a database engine to access, from the POS data, a set of purchase records that pertain to the personal identifier, wherein accessing the POS data comprises use of at least one of, a personal identifier, and a credential; and
an application server to execute the rules using the database engine to retrieve at least one aspect of a profile pertaining to personal identifier; and to analyze at least a portion of the set of purchase records to determine a nutrition value.

2. The system of claim 1, further comprising a nutrition lookup module to perform a nutrition lookup from a nutrition database.

3. The system of claim 1, further comprising storing the nutrition value in a database within a wellness program system.

4. The system of claim 1, wherein the personal identifier is derived from at least one of, a loyalty card, an electronic serial number, and an app.

5. The system of claim 1, wherein the aspect comprises at least one of, a meal, a shopping trip, a wellness target, and a nutrition target.

6. The system of claim 5, wherein the aspect comprises levelized data from one or more shopping trips.

7. The system of claim 1, further comprising a communication channel to transmit a nutrition suggestion based at least in part on the set of purchase records.

8. The system of claim 7, wherein the nutrition suggestion comprises a nutrition alert.

9. The system of claim 7, wherein the nutrition suggestion comprises a remediation recommendation based at least in part on the set of purchase records.

10. The system of claim 1, wherein the POS data comprises at least one of, a date, an item identifier, and a quantity measurement.

11. A method comprising:
retrieving from a database comprising a set of storage devices to hold a set of data records, wherein the data records comprise POS data having at least some items purchased relative to a personal identifier;
invoking a rules engine to ingest a set of one or more rules and to process the rules over the data records, the rules engine to access a rule base comprising a set of one or more processing rules for analysis of the POS data;
accessing, from the POS data, a set of purchase records that pertain to the personal identifier, wherein accessing the POS data comprises use of at least one of, a personal identifier, and a credential; and
executing the rules using the database engine to retrieve at least one aspect of a profile pertaining to personal identifier; and
analyzing at least a portion of the set of purchase records to determine a nutrition value.

12. The method of claim 11, further comprising performing a nutrition lookup from a nutrition database.

13. The method of claim 11, wherein the personal identifier is derived from at least one of, a loyalty card, an electronic serial number, and an app.

14. The method of claim 11, wherein the aspect pertaining to the personal identifier comprises at least one of, a meal, a shopping trip, a wellness target, and a nutrition target.

15. The method of claim 11, wherein the aspect pertaining to the personal identifier comprises levelized data from one or more shopping trips.

16. The method of claim 11, further comprising transmitting a nutrition suggestion based at least in part on the set of purchase records.

17. The method of claim 11, further comprising storing the nutrition value.

18. A computer program product, embodied in a non-transitory computer readable medium, the computer readable medium having stored thereon a sequence of instructions which, when executed by a processor causes the processor to execute a process, the process comprising:
retrieving from a database comprising a set of storage devices to hold a set of data records, wherein the data records comprise POS data having at least some items purchased relative to a personal identifier;
invoking a rules engine to ingest a set of one or more rules and to process the rules over the data records, the rules engine to access a rule base comprising a set of one or more processing rules for analysis of the POS data;
accessing, from the POS data, a set of purchase records that pertain to the personal identifier, wherein accessing the POS data comprises use of at least one of, a personal identifier, and a credential; and
executing the rules using the database engine to retrieve at least one aspect of a profile pertaining to personal identifier; and
analyzing at least a portion of the set of purchase records to determine a nutrition value.

19. The computer program product of claim 18, further comprising performing a nutrition lookup from a nutrition database.

20. The computer program product of claim 18, wherein the personal identifier is derived from at least one of, a loyalty card, an electronic serial number, and an app.
